(19) United States
(12) Patent Application Publication
(10) Pub. No.: US 2009/0184987 A1
(43) Pub. Date: Jul. 23, 2009

(54) RECORDING APPARATUS IN WHICH RECORDING MEDIUM IS HEATED AND METHOD FOR THE SAME

(75) Inventor: Osamu SHINKAWA, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/357,089

(22) Filed: Jan. 21, 2009

(30) Foreign Application Priority Data
Jan. 21, 2008 (JP) 2008-010101

(51) Int. Cl. B41J 2/01

(52) U.S. Cl. 347/1

(57) ABSTRACT

A recording apparatus includes a recording unit having a record head and ejecting liquid from the record head to record dots on a recording medium; a print-data generating unit that generates print data to be recorded on the recording medium; a heating unit that emits microwaves onto the recording medium to dry the liquid ejected from the record head and is partitioned into a plurality of radiation areas to be allowed to emit the microwaves from the individual radiation areas; a radiation-quantity determination unit that determines the quantities of the microwaves to be emitted from the individual radiation areas of the heating unit in accordance with the print data; and a radiation-quantity control unit that controls the quantities of the microwaves to be emitted from the individual radiation areas on the basis of the determination on the quantities of radiation of the microwaves.

### BACKGROUND

1. Technical Field

The present invention relates to a recording apparatus in which a recording medium is heated and a method for the same.

2. Related Art

One type of ink jet printers uses a print head (line head) having a width larger than that of recording media. This type does not need to move (scan) the print head (line head), thus remarkably increasing in throughput. However, if the number of print sheets per unit time increases extremely, recording media are printed one by one without sufficient drying time after ink adheres to the recording media. This causes the problems that the part of the printer which is in contact with the recording media becomes contaminated with ink, the recording media are stacked on an output tray or the like, so that the recording media becomes contaminated, or printing becomes blur because of rubbing when the recording media are stacked. Thus, a technique of evaporating water content in undried ink by applying microwaves onto the recording media is disclosed.

Here, if microwaves are partially applied to a paper-type recording medium, such as plain paper or photo paper, from the leading end to the trailing end during transportation, stress is applied to the recording medium when water content evaporates from the recording medium to cause deformation (curve) of the recording medium. To prevent such deformation of the recording medium, JP-A-2006-10889 proposes a method for heating the whole area of a recording medium for the same period of time at the same time.

Different quantities of different colors of ink, such as yellow, cyan, magenta, black, adhere to the recording surface of a recording medium in accordance with image information. The compositions of individual colors of ink are different, among which black includes carbon as a composition. Carbon is a material used to shield magnetic waves, as is ferrite. Therefore, black that includes carbon as a composition is prone to attract magnetic waves. Moreover, a specified kind of ink drops is sometimes concentrated on a specified portion of the recording surface.

Under such circumstances, if a fixed quantity of microwaves is applied to a recording medium for the same period of time at the same time, like the technique disclosed in JP-A-2006-10889, unevenness in heating will occur in accordance with the kind of color or the quantity of ejection, which can cause ignition according to circumstances. In addition, it is desirable to reduce the component count as much as possible in determining the quantity of radiation of microwaves.

### SUMMARY

An advantage of some aspects of the invention is that a recording apparatus which can apply microwaves in such a manner as to reduce unevenness in heating and in which the component count can be reduced and a method for the same are provided.

According to an aspect of the invention, there is provided a recording apparatus including a recording unit having a record head and ejecting liquid from the record head to record dots on a recording medium; a print-data generating unit that generates print data to be recorded on the recording medium; a heating unit that emits microwaves onto the recording medium to dry the liquid ejected from the record head and is partitioned into a plurality of radiation areas to be allowed to emit the microwaves from the individual radiation areas; a radiation-quantity determination unit that determines the quantities of the microwaves to be emitted from the individual radiation areas of the heating unit in accordance with the print data; and a radiation-quantity control unit that controls the quantities of the microwaves to be emitted from the individual radiation areas on the basis of the determination on the quantities of radiation of the microwaves.

With this configuration, the radiation-quantity determination unit determines the quantities of microwaves to be emitted from the individual radiation areas of the heating unit in accordance with the print data. The radiation-quantity control unit controls the quantities of microwaves to be emitted from the individual radiation areas on the basis of the determination on the quantities of radiation of microwaves. This allows the radiation quantities of microwaves to be determined from print data, thus eliminating the need for measuring the reflection quantity of microwaves. Since there is no need to measure the reflection quantity of microwaves, a component for the measurement becomes unnecessary, allowing reduction in cost. Moreover, different radiation quantities of microwaves can be set for individual different portions of the recording medium.

In this case, it is preferable that the radiation-quantity determination unit determine the quantities of radiation of the microwaves on the basis information in the print data on at least one of the ink colors and the sizes of dots to be recorded on partitioned areas corresponding to the partitioned radiation areas.

This configuration allows the optimum radiation quantities to be found for the colors and sizes of dots recorded. This allows appropriate quantities of microwaves to be applied to the individual partitioned areas. This allows unevenness in heating of a recording medium to be appropriately reduced, thereby allowing the degrees of dryness of the individual portions of the recording medium to be made even.

### BRIEF DESCRIPTION OF THE DRAWINGS

The invention will be described with reference to the accompanying drawings, wherein like numbers reference like elements.

FIG. 1 is a schematic diagram showing the configuration of a printer according to an embodiment of the invention.

FIG. 2 is a block diagram showing the electrical configuration of the printer in FIG. 1.

FIG. 3 is a schematic diagram showing the arrangement of a microwave radiation unit.

FIG. 4 is a bottom perspective view of a first block as viewed obliquely from below.

FIG. 5 is a diagram showing programs stored in a computer.

FIG. 6 is a diagram showing the relationship between the partitioned areas of a print image and blocks.

FIG. 7 is a flowchart showing the outline of the operation of the printer.

### DESCRIPTION OF EXEMPLARY EMBODIMENTS

### Embodiment

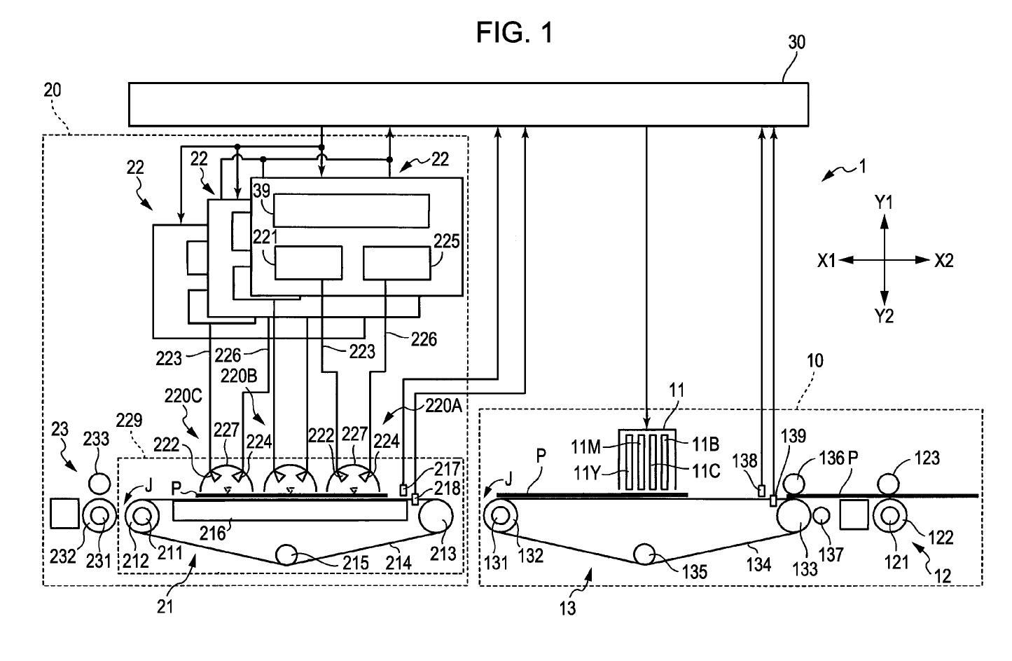

A recording apparatus according to an embodiment of the invention will be described hereinbelow with reference to FIGS. 1 to 7. The recording apparatus of this embodiment includes a printer 1 and a computer 40.

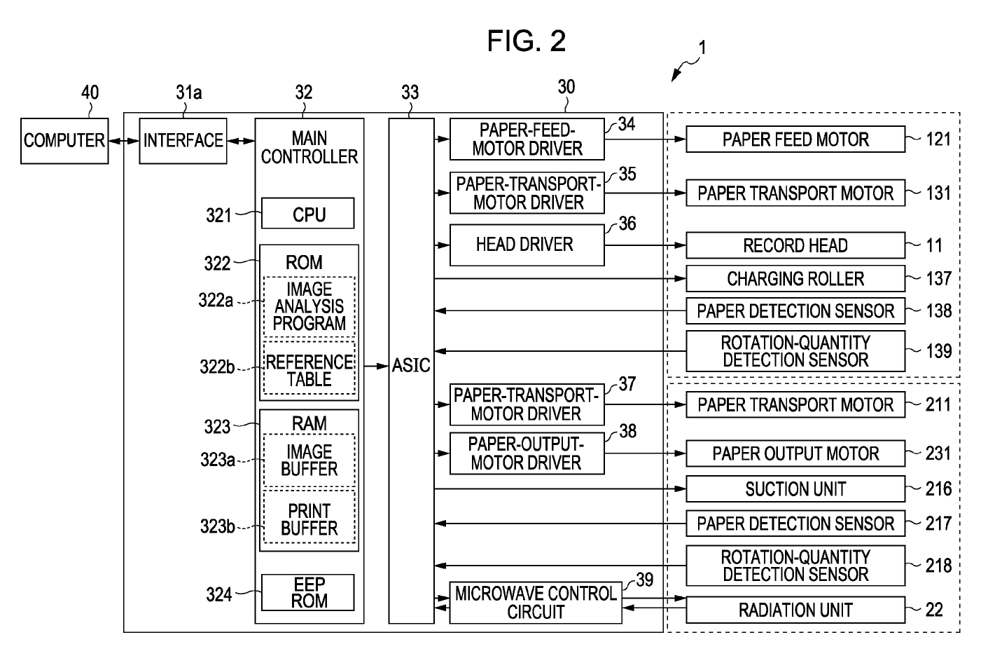

FIG. 1 is a schematic diagram showing the configuration of the printer 1. In the following description, direction X1 is the front, direction X2 is the back, direction Y1 is the top, direction Y2 is the bottom, the right as viewed from the back to the front is the right, and the left as viewed from the back to the front is the left. FIG. 2 is a schematic circuit block diagram showing the electrical configuration of the printer 1.

### Overall Configuration

The printer 1 includes a recording section 10 that performs recording onto recording paper P corresponding to a recording medium, a heating section 20 that constitutes a recording-medium heating unit for heating the recording paper P output from the recording section 10, and a system control section 30 that controls the recording section 10 and the heating section 20. Among them, the heating section 20 and the system control section 30 correspond to the recording-medium heating unit.

The recording section 10 records on the recording paper P by ejecting ink onto the recording paper P. Therefore, the recording paper P output from the recording section 10 becomes wet with water content that is the solvent of the ink. This wet recording paper P is transported to the heating section 20, where the recording paper P is irradiated with microwaves. This irradiation with microwaves causes the water content of the applied ink to be heated and so evaporation is promoted, so that the recording paper P is dried in a short time. As will be described later, the heating section 20 is configured to control the quantity of radiation (or the intensity of radiation) of microwaves in accordance with the wetness of the recording paper P, that is, the degree of dryness. In other words, the heating section 20 is configured to prevent the recording paper P heated by the heating section 20 from burning because of overheating, being deteriorated because of heat, or conversely, being insufficiently dried.

### Configuration of Recording Section 10

First, the configuration of the recording section 10 will be described. The recording section 10 includes a record head 11 that ejects ink onto the recording paper P, a paper feeding section 12 that feeds the recording paper P to a paper transport section 13, and the paper transport section 13 that transports the recording paper P from the back to the front below the record head 11.

The paper feeding section 12 includes a paper feed motor 121, a paper feed roller 122 that is rotationally driven by the paper feed motor 121, and a driven roller 123 that is paired with the paper feed roller 122. The paper feed roller 122 and the driven roller 123 are slightly longer than the lateral width of the recording paper P. The driven roller 123 presses the recording paper P against the paper feed roller 122, with the recording paper P put between the paper feed roller 122 and the driven roller 123. Thus, the recording paper P is fed to the forward paper transport section 13 by the rotation of the paper feed roller 122. The driven roller 123 rotates with the movement of the recording paper P.

The paper transport section 13 includes a paper transport motor 131, a paper transport roller 132, a driven roller 133, and a paper transport belt 134. The paper transport roller 132 is disposed ahead of the record head 11 and is rotationally driven by the paper transport motor 131. The driven roller 133 is disposed behind the paper transport roller 132, with the record head 11 therebetween. The endless paper transport belt 134 is stretched between the paper transport roller 132 and the driven roller 133.

A tension roller 135 that applies tension to the paper transport belt 134 is provided below between the paper transport roller 132 and the driven roller 133. The paper transport belt 134 is slightly longer than the lateral width of the recording paper P. A paper bail roller 136 is disposed above the driven roller 133.

The recording paper P, which is fed from the paper feeding section 12 to the paper transport section 13, is fed in such a manner as to be inserted between the paper bail roller 136 and the paper transport belt 134. The paper bail roller 136 applies a pressing force toward the paper transport belt 134 to the recording paper P. The paper transport roller 132 rotates to the left in FIG. 1 (in the direction of arrow J in FIG. 1). With this rotation, the part of the paper transport belt 134 stretched over between the paper transport roller 132 and the driven roller 133 (the part on which the recording paper P is placed) moves from the back to the front. Thus, the recording paper P fed, from the paper feeding section 12, in between the paper transport belt 134 and the paper bail roller 136 is transported from the back to the front while being placed on the paper transport belt 134.

The paper transport belt 134 is formed of a material that is readily electrified, such as PET. A charging roller 137 for electrifying the paper transport belt 134 is provided behind the driven roller 133 and in contact with the paper transport belt 134. The charging roller 137 electrifies the paper transport belt 134. Since the paper transport belt 134 is electrified by the charging roller 137, the recording paper P transported on the paper transport belt 134 is electrostatically attracted to the paper transport belt 134. Since the recording paper P is pressed by the paper bail roller 136 against the paper transport belt 134, as described above, the recording paper P is surely electrostatically attracted to the paper transport belt 134.

There are provided, ahead of the driven roller 133, a paper detection sensor 138 for sensing the presence of the recording paper P on the paper transport belt 134 and a rotation-quantity detection sensor 139 for sensing the rotation of the paper transport belt 134.

The paper detection sensor 138 includes a flood lamp and a light receiver (not shown), and so it can sense the presence of the recording paper P, for example, in white, on the paper transport belt 134, for example, in black, from the difference in reflected light quantity between when the recording paper P is present on the paper transport belt 134 and when it is absent. The rotation-quantity detection sensor 139 constitutes an optical encoder together with a linear scale (not shown) provided along the left edge of the paper transport belt 134 and along the whole circumference of the paper transport belt 134. Thus, the quantity of the recording paper P transported by the paper transport section 13 can be measured on the basis of the detection results by the paper detection sensor 138 and the rotation-quantity detection sensor 139.

### Configuration of Record Head 11

The record head 11 is, for example, a long line record head having a record width that allows ink (corresponding to liquid) to be ejected along the lateral width of the recording paper P at a time, in which record heads 11B, 11C, 11M, and 11Y corresponding to black, cyan, magenta, and yellow inks, respectively, are arranged in the front-to-back direction. In response to a driving signal from a head driver 36, the record head 11 ejects the color inks onto predetermined portions of the recording paper P that is transported forward by the paper transport belt 134, thereby recording a predetermined image or character onto the recording paper P. The record head 11 may not be the long line head but may be formed of alternate short heads.

### Configuration of Heating Section 20

Next, the configuration of the heating section 20 will be described. The heating section 20 corresponds to a heating unit and includes a paper transport section 21 serving as a moving section for transporting the recording paper P from the back to the front, a microwave radiation unit 22 that radiates microwaves onto the recording paper P, and a paper output section 23.

The paper transport section 21 includes a paper transport motor 211, a paper transport roller 212, a driven roller 213, a paper transport belt 214, and a tension roller 215. Since the functions of the paper transport motor 211, the paper transport roller 212, the driven roller 213, the paper transport belt 214, and the tension roller 215 are the same as those of the paper transport motor 131, the paper transport roller 132, the driven roller 133, the paper transport belt 134, and the tension roller 135 of the paper transport section 13 described above, their descriptions will be omitted. However, the paper transport roller 212 is disposed ahead of microwave radiating sections 222 and microwave receiving sections 224 provided in the microwave radiation unit 22, and the driven roller 213 is disposed behind the paper transport roller 212, with the microwave radiating sections 222 and the microwave injecting sections 224 therebetween.

A suction unit 216 is provided at the inner circumference of the paper transport belt 214, that is, the lower part (back) of the paper transport belt 214 stretched over the paper transport roller 212 and the driven roller 213. The suction unit 216 has suction holes (not shown) so as to face the paper transport belt 214. On the other hand, the paper transport belt 214 has a plurality of small holes (for example, 1 mm in diameter) arranged lengthwise and crosswise at predetermined intervals. Thus, when the suction unit 216 performs a sucking action, a sucking force acts on the outer circumferential surface of the paper transport belt 214 through the small holes formed in the paper transport belt 214 to allow the recording paper P being transported to be sucked.

The suction holes of the suction unit 216 are provided substantially over the whole area from the paper transport roller 212 to the driven roller 213. Thus, the recording paper P, which is transported on the paper transport belt 214, is maintained flat in accordance with the degree of flatness of the paper transport belt 214, without being levitated by wind pressure during transportation or becoming wavy or curled. There are provided, ahead of the driven roller 133, a paper detection sensor 217 for sensing the presence of the recording paper P on the paper transport belt 214 and a rotation-quantity detection sensor 218 for sensing the rotation of the paper transport belt 214. Since the configurations of the paper detection sensor 217 and the rotation-quantity detection sensor 218 are the same as those of the paper detection sensor 138 and the rotation-quantity detection sensor 139, their descriptions will be omitted.

The recording paper P is fed from the paper transport section 21 to the paper output section 23 and is output to a stacker (not shown) provided ahead of the paper output section 23. The paper output section 23 includes a paper output motor 231, a paper output roller 232 that is rotationally driven by the paper output motor 231, and a driven roller 233 that is paired with the paper output roller 232. Thus, the recording paper P that is fed out from the paper transport section 21 is fed to the receiving stacker (not shown) by the paper output roller 232 and the driven roller 233.

### Configuration of Microwave Radiation Unit 22

The heating section 20 includes a plurality of the microwave radiation units 22. The microwave radiation units 22 each include a microwave oscillator circuit 221 and the microwave radiating section 222 serving as a microwave radiating device for radiating microwaves, a waveguide 223 that connects the microwave oscillator circuit 221 and the microwave radiating section 222 together, a microwave receiving section 224 and a microwave receiver circuit 225 serving as a microwave receiving device, and a waveguide 226 that connects the microwave receiving section 224 and the microwave receiver circuit 225 together.

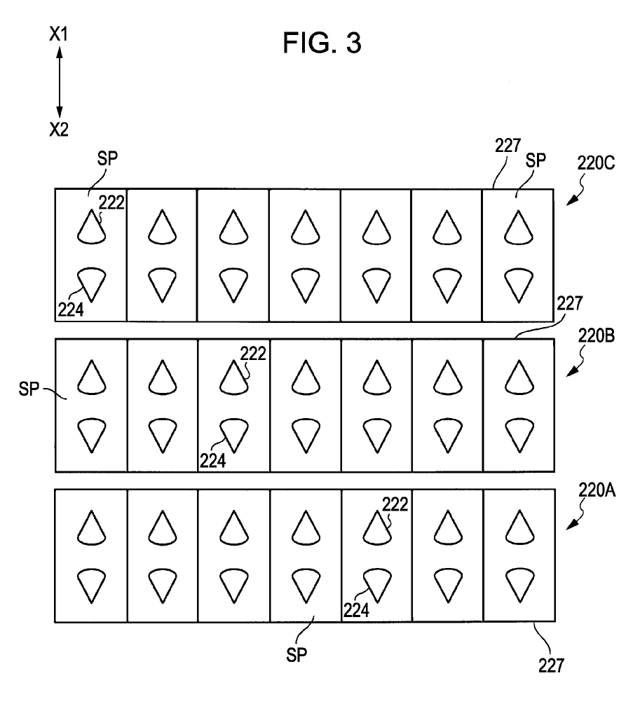

This embodiment includes, for example, 21 microwave radiation units 22 and 21 sets of the microwave radiating section 222 and the microwave receiving section 224. As schematically shown in FIG. 3, the 21 sets of the microwave radiating section 222 and the microwave receiving section 224 are arranged in seven columns in the lateral direction and in three rows in the front-to-back direction along the transport surface of the paper transport belt 214 on the suction unit 216. The set of the microwave radiating section 222 and the microwave receiving section 224 are arranged in the front-to-back direction, that is, in the direction of transportation of the recording paper P. FIG. 1 shows three sets arranged in three rows in the front-to-back direction, each row of which has seven sets of the microwave radiating section 222 and the microwave receiving section 224 toward the back of this drawing, that is, on the right. In the following description, a first block 220A, a second block 220B, and a third block 220C from the back row will be described, with the microwave radiation unit 22 corresponding to seven sets of the microwave radiating section 222 and the microwave receiving section 224 of each of rows arranged in the front-to-back direction as one block.

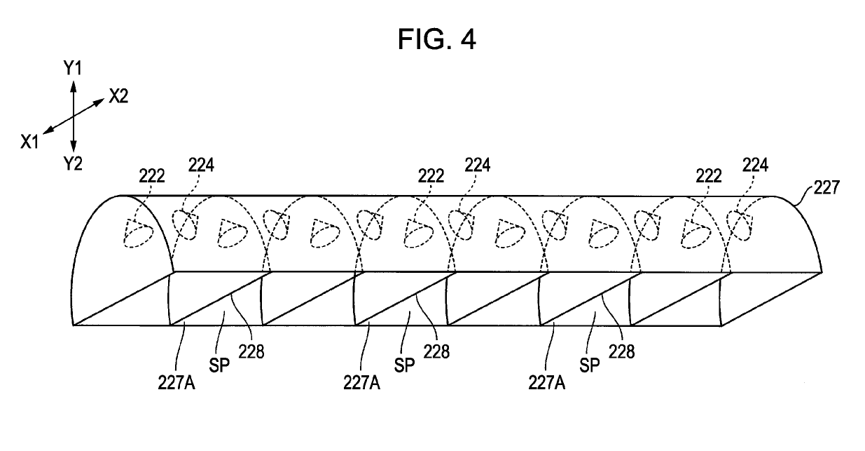

As shown in FIG. 4, there is provided a microwave absorbing plate 227 above the microwave radiating section 222 and the microwave receiving section 224 of each of the blocks 220A, 220B, and 220C. FIG. 4 is a bottom perspective view of the microwave radiating section 222 and the microwave receiving section 224 of the first block 220A as viewed obliquely from below. The second block 220B and the third block 220C have the same configuration.

The microwave absorbing plate 227 has a semicylindrical dome shape in which an opening 227A is directed downward and the generators of the cylinder are directed in the lateral direction. The semicylinder has partition plates 228, with which the interior of the semicylinder is partitioned at regular intervals into seven spaces SP. The spaces SP each have one set of the microwave radiating section 222 and the microwave receiving section 224.

The microwave absorbing plate 227 and the partition plates 228 are made of a material that shields or absorbs microwaves, such as a metal plate coated in black. Thus, microwaves radiated from the microwave radiating section 222 is shielded so as not to enter the microwave receiving sections 224 of different sets. The microwave absorbing plate 227 and the partition plates 228 may be formed of another material that reflects or shields microwaves. The black coating on the metal plate may be applied only to the partition plates 228.

The whole of the paper transport section 21 and the blocks 220A, 220B, and 220C are covered with a microwave shield casing 229 formed of a metal plate or the like coated in black, for example, so that microwaves radiated from the microwave radiating section 222 does not leak out of the microwave shield casing 229.

The microwave radiating section 222 is connected to the microwave oscillator circuit 221 that oscillates microwaves through the waveguide 223. The microwave receiving section 224 is connected to the microwave receiver circuit 225 that receives microwaves through the waveguide 226. The microwave oscillator circuit 221 and the microwave receiver circuit 225 are connected to a microwave control circuit 39. The microwave oscillator circuit 221 is provided with a magnetron (not shown). Microwaves are generated when voltage is applied to the magnetron. The microwaves generated by the magnetron propagate through the waveguide 223 and are then emitted from the microwave radiating sections 222 to different parts of the recording paper P.

The microwave receiving sections 224 are arranges so that the microwaves which are radiated from the paired microwave radiating sections 222 onto the recording paper P and reflected by the recording paper P are incident thereon. The microwaves incident on the microwave receiving sections 224 propagate through the waveguides 226 and are received by microwave receiving portions of the microwave receiver circuit 225. The microwave receiver circuit 225 converts the microwaves to a voltage corresponding to the quantity of the received microwaves and outputs the voltage to the microwave control circuit 39.

### Configuration of System Control Section 30

Referring to FIG. 2 and other drawings, the configuration of the system control section 30 will next be described. The system control section 30 of the printer 1 includes an interface 31a, a main controller 32, an application specific integrated circuit (ASIC) 33, a paper-feed-motor driver 34 for controlling the driving of the paper feed motor 121, a paper-transport-motor driver 35 for controlling the driving of the paper transport motor 131, the head driver 36 for controlling the driving of the record head 11, a paper-transport-motor driver 37 for controlling the driving of the paper transport motor 211, a paper-output-motor driver 38 for controlling the driving of the paper output motor 231, and the microwave control circuit 39 (corresponding to a part of a radiation-quantity control unit).

The main controller 32 corresponds to a radiation-quantity determination unit and constitutes the main part of the radiation-quantity control unit. The main controller 32 includes a central processing unit (CPU) 321 that controls various operations of the printer 1 on the basis of image forming data or the like sent from the computer 40, including controlling the ejection of the record head 11, controlling the driving of the paper feed motor 121 and the paper transport motor 131, and controlling electrification of the charging roller 137; a read-only memory (ROM) 322; a random access memory (RAM) 323 which is a memory for operation; and an electrically erasable programmable read-only memory (EEPROM) 324 for storing image forming data and the like input from the computer 40 through the interface 31a.

The main controller 32 controls the rotational speeds of the paper feed motor 121 and the paper transport motor 131 in accordance with image forming data and a signal output from the ASIC 33 and controls the driving of the record head 11 so that inks of predetermined colors are ejected onto predetermined positions of the recording paper P to record images or the like onto the recording paper P. The recorded recording paper P is transported toward the heating section 20 by the paper transport section 13.

The ROM 322 stores processing programs for various operations of the printer 1. In addition, the ROM 322 stores an image analysis program 322a for determining a radiation quantity ME, to be described later, and a reference table 322b. The image analysis program 322a stores a predetermined quantity of print data PD in a buffer (hereinafter referred to as an image buffer 323a) of the RAM 323, and when the stored print data PD reaches a predetermined quantity, partitions it into several areas, for each of which the image analysis program 322a determines a radiation quantity of microwaves (microwave energy) ME. Preferably, the RAM 323 has a print buffer 323b for use in printing, in addition to the image buffer 323a.

### Configuration of Computer 40

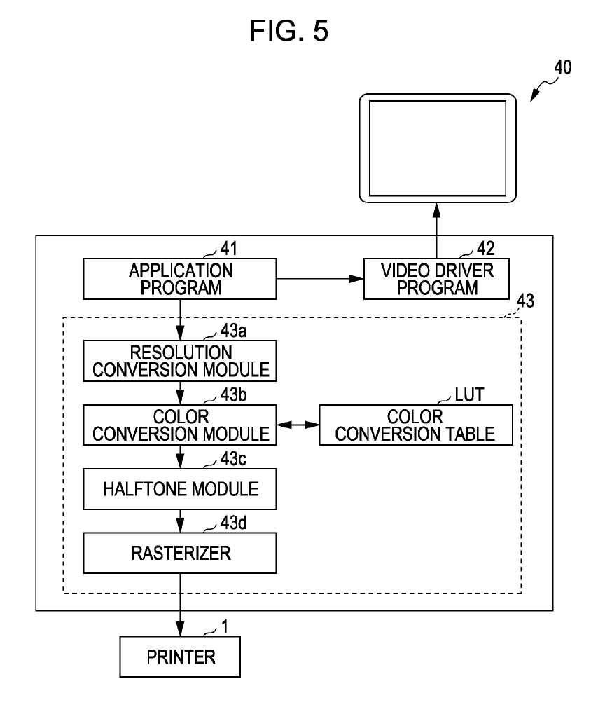

Next, the configuration of the computer 40 connected to the printer 1 will be described with reference to FIG. 5. The computer 40 includes a CPU, a ROM, a RAM, a hard disk, and an interface (not shown), in which an application program 41, a video driver program 42, and a printer driver program 43 can be operated under a predetermined operating system. Among them, the application program 41 outputs print data PD to be transferred to the printer 1 via the printer driver program 43.

The video driver program 42 displays a predetermined image (for example, a user interface) on a display according to an instruction from the application program 41, the printer driver program 43 or the like.

The computer 40 also serves as a print-data generating unit when the printer driver program 43 is started. The printer driver program 43 receives image data from the application program 41 in response to a print instruction from the application program 41 and converts the image data to print data PD to be supplied to the printer 1. The printer driver program 43 includes a resolution conversion module 43a, a color conversion module 43b, a halftone module 43c, a rasterizer 43d, and a color conversion table LUT.

The resolution conversion module 43a performs the process of converting the resolution of color image data formed by the application program 41 to a resolution at which the printer 1 prints (for example, for the printer 1 having a resolution of 720 dpi×720 dpi, converting the resolution of image data to a resolution of 720 dpi×720 dpi). Image data after the conversion is still image information composed of three RGB color components. The color conversion module 43b converts the RGB image data to multiple-tone data in multiple ink colors that the printer 1 can use from pixel to pixel. For example, if the printer 1 is a four CMYK color printer, multiple-tone data subjected to color conversion becomes CMYK data of, for example, 256 levels of gray.

The halftone module 43c performs the process of converting the above-described multiple-tone data (CMYK data) to data with the number of gray levels of the printer 1. For example, if the record head 11 can express only two levels of gray by turning on and off ink drops, the halftone module 43c converts the CMYK data to 1-bit data for individual pixels (dots), and if the record head 11 can selectively eject large, middle-sized, and small ink drops, in addition to the turning on/off of ink drops, the halftone module 43c performs the process of converting the CMYK data to 1-bit data for individual pixels. In the halftone processing, pixels (dots) are dispersed to form image data by dithering, γ correction, or error diffusion.

The rasterizer 43d performs the process of rearranging image data after halftone processing in order of data to be transferred to the printer 1. The image data after the rasterization is output as the final print data PD to the printer 1. The print data PD also includes data indicating the quantity of subscanning feeding.

The functions of the image analysis program 322a and the reference table 322b may be provided to the printer driver program 43. In this case, analyzing image data after halftone processing or rasterization allows the quantity of radiation of microwaves to a specified partitioned area to be calculated without storing a predetermined quantity of print data PD in the image buffer 323a.

### Operation of Recording Apparatus

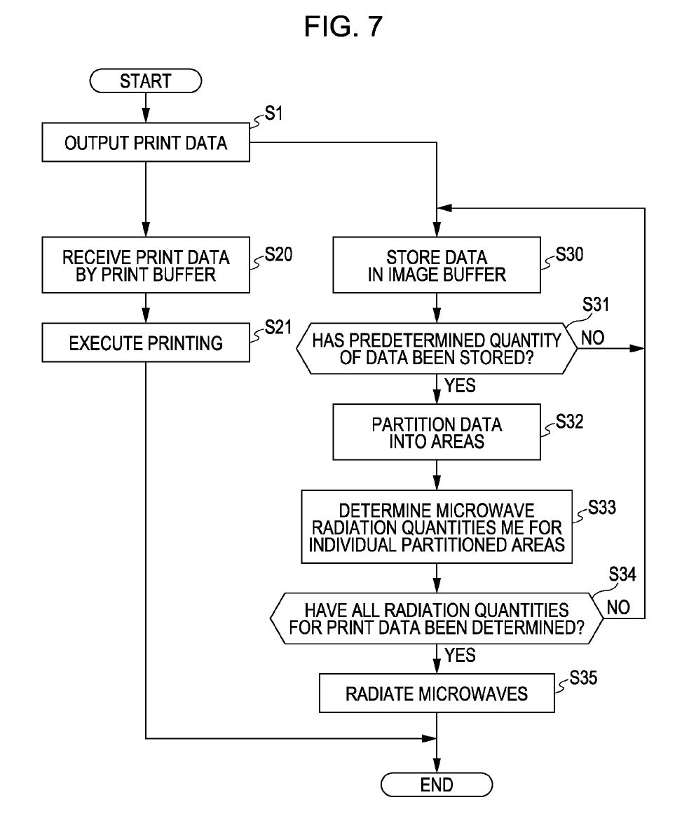

Next, the operation of the recording apparatus will be described with reference to the flowchart in FIG. 7. When an instruction to print image data generated by the application program 41 of the computer 40 is given, the printer driver program 43 executes resolution conversion processing, color conversion processing, halftone processing, and rasterizing processing in sequence. The computer 40 then outputs print data PD to the printer 1 (step S1).

The print data PD is sent to the image buffer 323a and the print buffer 323b and is stored in the print buffer 323b in sequence (S20). When the print data PD after the rasterization is transferred to the print buffer 323b one by one, the record head 11 executes printing according to the print data PD (S21), and, for example, when printing of one scanning in the main scanning direction is completed, print data PD for new scanning is overwritten in sequence.

The printer 1 executes printing by the record head 11 and stores the print data PD in the image buffer 323a (S30). Then, the printer 1 determines whether the quantity of the print data PD in the image buffer 323a has reached a predetermined quantity (S31). If it is determined that a predetermined quantity of print data PD has been stored (YES), then the stored print data PD is partitioned into areas, to be described later (S32). The main controller 32 of the printer 1 starts the image analysis program 322a. The image analysis program 322a determines the radiation quantities ME of microwaves for the individual partitioned areas with reference to the reference table 322b (S33).

If it is determined in the determination of S31 that the quantity of the print data PD has not reached the predetermined value, then the process returns to S30.

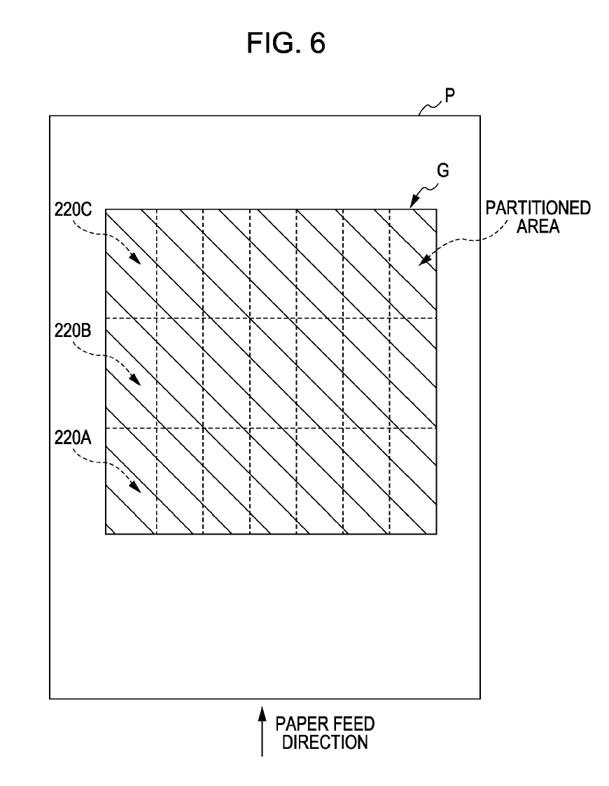

FIG. 6 is a diagram showing an example of partition of the areas. FIG. 6 shows a print image G printed on the recording paper P and the blocks 220A, 220B, and 220C and the spaces SP on the print image G. FIG. 6 assumes that the print image G and the total area of the blocks 220A, 220B, and 220C are substantially equal for purpose of simplification of description. In the following description, the portions of the print image G corresponding to the spaces SP are referred to as partitioned areas.

A detailed example of determination of the radiation quantities ME of the partitioned areas will be described with reference to FIG. 6. For example, assuming that a dot corresponding to one pixel is cyan, a radiation quantity ΔMEc necessary for drying one cyan dot is found in advance by experiment or the like and is stored in the reference table 322b of the ROM 322. Then, the image analysis program 322a calculates the number of cyan dots in a specified partitioned area. The image analysis program 322a finds a radiation quantity ΔMEc necessary for drying all the cyan dots in the specified partitioned area using the following Eq. 1.

MEc=ΔMEc×N Eq. 1

where N is the number of cyan dots in the specified partitioned area.

This is an example of cyan. The image analysis program 322a finds a radiation quantity MEm (microwave energy) necessary for drying all magenta dots, a radiation quantity MEy necessary for drying all yellow dots, and a radiation quantity MEk necessary for drying all black dots in the same manner. The total radiation quantity ME of microwaves in the specified partitioned area is found by the following Eq. 2.

ME=MEc+MEm+MEy+MEk Eq. 2

It is preferable that the reference table 322b held in the ROM 322 be provided for individual kinds of recording paper P because the degree of penetration of ink and the reflectance of microwaves depend on the kind of recording paper P. The above example is for cyan dots. If different sizes of dots, that is, large dots, middle-sized dots, and small dots, can be selectively ejected, radiation quantities necessary for drying individual dots of different sizes are found in advance by experiment or the like. Alternatively, radiation quantities necessary for drying individual dots of different sizes may not be found by experiment but may be calculated from the volume ratio among a large dot, a middle-sized dot, and small dot.

The determination of the radiation quantity ME based on a predetermined buffer quantity of the print data PD is continued until determination on all the print data PD is completed (S34).

When the radiation quantities ME of individual partitioned areas are determined as described above, microwaves are radiated from the first blocks 220A to the third block 220C onto the recording paper P by the determined radiation quantities ME, respectively, when the partitioned areas come to the first block 220A to the third block 220C. Since microwaves are radiated from three blocks, that is, the first block 220A, the second block 220B, and the third block 220C, a specified partitioned area of the print image G is irradiated three times. Therefore, the blocks 220A, 220B, and 220C may individually radiate a radiation quantity ME/3 of microwaves in accordance with Eq. 1. The radiation quantities may not necessarily be even ME/3 each but may be weighted to any of the blocks 220A, 220B, and 220C.

FIG. 6 assumes that the size of the print image G is substantially equal to the total area of the blocks 220A, 220B, and 220C for purpose of simplification of description. Although the size of the print image G and the total area of the blocks 220A, 220B, and 220C are not generally equal in the direction of feeding of the recording paper P, all the partitioned areas pass the blocks 220A, 220B, and 220C, and thus the total of the radiation quantities at the partitioned areas amounts to ME.

Microwaves of the radiation quantity ME determined as described above are applied onto the recording paper P (S35). Thus, the print image G is dried.

### ADVANTAGES OF THE INVENTION

The recording apparatus with this configuration determines the quantities of microwaves to be radiated from the individual radiation areas of the heating section 20 in accordance with print data for driving the record head 11. The main controller 32 controls the quantities of microwaves to be radiated from the individual radiation areas of the heating section 20 in accordance with the determined radiation quantities. This allows the radiation quantities of microwaves to be determined from print data, thus eliminating the need for measuring the reflection quantity of microwaves. Since there is no need to measure the reflection quantity of microwaves, a component for the measurement becomes unnecessary, allowing reduction in cost.

The heating section 20 has the plurality of microwave radiating sections 222. The individual microwave radiating sections 222 can apply microwaves to different portions of the recording paper P. This allows different radiation quantities of microwaves to be set for individual different portions of the recording paper P.

Furthermore, the main controller 32 partitions the print data PD into a plurality of areas and determines radiation quantities of microwaves for the individual microwave radiating sections 222 corresponding to individual partitioned areas. Therefore, radiation quantities of microwaves are determined for individual partitioned areas of the print data PD. This allows appropriate quantities of microwaves to be applied to the individual partitioned areas. This allows unevenness in heating of the recording paper P to be appropriately reduced, thereby allowing the degrees of dryness of the individual portions of the recording paper P to be made even.

The main controller 32 analyzes the print data PD by the image analysis program 322a with reference to the reference table 322b of the ROM 322 and calculates the quantities of inks to be ejected and the radiation quantities of microwaves necessary for drying the inks. Thus, the radiation quantities of microwaves can be determined by calculation and unevenness in heating of a recording medium can be appropriately reduced, so that the degree of dryness of the individual portions can be made even.

### Modifications

While an embodiment of the invention is described above, the invention can be modified in various ways. Modifications will be described below.

While the recording apparatus of the above embodiment includes the microwave receiving sections 224 and the microwave receiver circuit 225, the invention may adopt a configuration in which the microwave receiving section 224 and the microwave receiver circuit 225 are omitted.

While the above embodiment is configured such that the radiation quantity ME is determined using Eq. 1 and Eq. 2, the radiation quantity ME may be determined in consideration of other factors. Examples of other factors include absorption of microwaves to the outside.

The above embodiment may be modified such that the reflection quantity of microwaves is detected using the microwave receiving section 224, the microwave receiver circuit 225 and the like after a determined quantity ME of microwaves is applied. In the case where the reflection quantity of microwaves is detected, the radiation quantity of microwaves may be determined by feedback control according to the reflection quantity.

While the above embodiment is configured such that inks that are ejected from the record head 11 are in four colors, black, cyan, magenta, and yellow, it may not necessarily be in four colors but may be in five or more colors.

The entire disclosure of Japanese Patent Application No: 2008-010101, filed Jan. 21, 2008 is expressly incorporated by reference herein.

What is claimed is:

1. A recording apparatus comprising:
a recording unit having a record head and ejecting liquid from the record head to record dots on a recording medium;
a print-data generating unit that generates print data to be recorded on the recording medium;
a heating unit that emits microwaves to the recording medium to dry the liquid ejected from the record head and is partitioned into a plurality of radiation areas to be allowed to emit the microwaves from the individual radiation areas;
a radiation-quantity determination unit that determines the quantities of the microwaves to be emitted from the individual radiation areas of the heating unit in accordance with the print data; and
a radiation-quantity control unit that controls the quantities of the microwaves to be emitted from the individual radiation areas on the basis of the determination on the quantities of radiation of the microwaves.

2. The recording apparatus according to claim 1, wherein the radiation-quantity determination unit determines the quantities of radiation of the microwaves on the basis information in the print data on at least one of the ink colors and the sizes of dots to be recorded on partitioned areas corresponding to the partitioned radiation areas.

3. A method for recording, comprising:
ejecting liquid from a record head to record dots on a recording medium;
generating print data to be recorded on the recording medium;
emitting microwaves to the recording medium from individual partitioned radiation areas to dry the liquid ejected from the record head;
determining the quantities of the microwaves to be emitted from the individual radiation areas of the heating unit in accordance with the print data; and
controlling the quantities of the microwaves to be emitted from the individual radiation areas on the basis of the determination on the quantities of radiation of the microwaves.
